(19) United States
(12) Patent Application Publication
(10) Pub. No.: US 2015/0358368 A1
(43) Pub. Date: Dec. 10, 2015

(54) NETWORK OPTIMIZATION OF PEER-TO-PEER TELECONFERENCING

(71) Applicant: CafeX Communications, Ltd., Cardiff (GB)

(72) Inventors: KEVIN J. WISEMAN, Cardiff (GB); Kevin J. Glass, Cardiff (GB); John Holvey, Cardiff (GB); Alexander R. Lewis, Cardiff (GB)

(73) Assignee: CafeX Communications, Ltd., Cardiff (GB)

(21) Appl. No.: 14/295,430

(22) Filed: Jun. 4, 2014

(51) Int. Cl. H04L 29/06; H04L 29/08

(52) U.S. Cl. CPC H04L 65/1093; H04L 65/608; H04L 67/104

(57) ABSTRACT

Systems (100) and methods (900) for controlling distribution of media streams during a teleconference. The methods comprise: configuring, by a central controller (102), a media stream flow between user nodes (106-132) which are participating or are to participate in the teleconference based on one or more first parameters; periodically determining, by the central controller, an end-to-end latency for each pair of the user nodes during the teleconference; and dynamically re-configuring, by the central controller, the media stream flow between the user nodes participating in the teleconference in view of the end-to-end latencies which were previously determined. The media stream flow is configured/re-configured by ordering the user nodes into a daisy chain structure (300, 400), a tree structure (500, 600, 602) or a hybrid structure (700, 800). The structure in which the user nodes are configured can be different than the structure in which the user nodes are subsequently re-configured.

### FIELD OF THE INVENTION

This document relates generally to peer-to-peer teleconferencing. More particularly, this document relates to implementing systems and methods for controlling the distribution of data within a peer-to-peer teleconference.

### BACKGROUND OF THE INVENTION

Teleconferences where all participants actively stream media have scaling issues. Multipoint Control Unit (“MCU”) based teleconferences are limited in scale (both in number and size) by the resource capabilities of the MCU. In this regard, it should be understood that the MCU only supports a limited number of teleconferences, where each teleconference has less than or equal to a given number of participants. Also, the MCU has only a limited number of ports available thereon. It is relatively expensive to scale up the MCU infrastructure. Mesh based. teleconferences require each participant to steam media to and from each other participant (N-1 streams per participant). There is no limit on the number of teleconferences as no dependence on a central server to mix media content. However, the number of participants is limited by the participant with the most constrained network bandwidth. Consumer internet connections (e.g., broadband) tend to be asynchronous with significantly more download capacity than upload. The participants are restricted by their ability to send streams. Therefore, mesh based teleconferencing needs creative solutions to work around network (especially upload) connectivity limits.

### SUMMARY

The present invention concerns implementing systems and methods for controlling distribution of media streams during a teleconference. The methods involve configuring, by a central controller, a media stream flow between user nodes which are participating or are to participate in the teleconference based on one or more first parameters. The first parameters include, but are not limited to, an end-to-end latency for each pair of user nodes and an active/inactive status of each user node. A user node with an active status is a node in which the user thereof is actively participating in a teleconference by at least speaking to other participants. A user node with an inactive status is a node in which the user thereof is an inactive participant of a teleconference by simply listening to other speakers (and not speaking). The active/inactive status does not comprise a binary value, but rather information representing a degree of user activity over time that can be used to determine candidates for repositioning in a change of media stream flow.

Next, the central controller performs operations to periodically determine an end-to-end latency for each pair of the user nodes during the teleconference. In view of the end-to-end latencies which were previously determined, the central controller dynamically re-configures the media stream flow between the user nodes participating in the teleconference. The media stream flow may be dynamically re-configured based on at least one of a number of participants of the teleconference, the end-to-end latencies determined for each pair of the user nodes, an active/inactive status of each user node, and a capacity of at least one user node to handle all or a portion of a media stream load of the teleconference.

The media stream flow is configured or re-configured by ordering the user nodes into a Network Node Communication (“NNC”) architecture. The NNC architecture can include, but is not limited to, daisy chain structure, a tree structure or a hybrid structure. In the daisy chain structure, each user node sends media streams exclusively to a first user node and receives media streams exclusively from a second different user node. In some scenarios, the media streams received by each user node are absent of a media stream generated by that user node. Alternatively, if there is sufficient network capacity, then all media streams might be sent to all participants to reduce the work on the individual user nodes in updating the media stream. In the tree structure, at least a first user node having an active status communicates a media stream generated thereby to at least one second user node having an inactive status. The second user node may act as a relay node by forwarding the media stream generated by the first user node to at least one third user node having an inactive status. In the hybrid structure, at least first and second user nodes are ordered into a daisy chain architecture for distribution of media streams during the teleconference and at least third and fourth user nodes are ordered into a tree architecture for distribution of media streams during the teleconference.

In some cases, the user nodes are configured into a first NNC architecture for distribution of media streams during the teleconference, and subsequently re-configured into a second different NNC architecture for distribution of media streams during the teleconference. For example, the user nodes are first configured into a daisy chain structure, and then subsequently configured into a tree structure or hybrid structure. Additionally or alternatively, the central controller dynamically changes a quality of a media stream associated with one of the user nodes during the teleconference.

### DESCRIPTION OF THE DRAWINGS

Embodiments will be described with reference to the following drawing figures, in which like numerals represent like items throughout the figures, and in which:

FIG. 1 is a schematic illustration of an exemplary system that is useful for understanding the present invention.

FIG. 2 is a block diagram of an exemplary architecture for the central controller of FIG. 1.

FIG. 3 is a schematic illustration of an exemplary daisy chain architecture that is useful for understanding the flow of media streams amongst a plurality of user nodes participating in a teleconference.

FIG. 4 is a schematic illustration of another exemplary daisy chain architecture that is useful for understanding the flow of media streams amongst a plurality of user nodes participating in a teleconference.

FIG. 5 is a schematic illustration of an exemplary tree architecture that is useful for understanding the flow of media streams amongst a plurality of user nodes participating in a teleconference.

FIG. 6 is a schematic illustration of an exemplary NNC architecture that is useful for understanding the flow of media streams amongst a plurality of user nodes participating in a teleconference.

FIG. 7 is a schematic illustration of an exemplary hybrid architecture that is useful for understanding the flow of media streams amongst a plurality of user nodes participating in a teleconference.

FIG. 8 is a schematic illustration of another exemplary hybrid architecture that is useful for understanding the flow of media streams amongst a plurality of user nodes participating in a teleconference.

FIGS. 9A-9C collectively provide a flow diagram of an exemplary method for controlling the distribution of media streams during a teleconference.

FIGS. 10A-10B collectively provide a flow diagram of another exemplary method for controlling the distribution of media streams during a teleconference.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated. by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

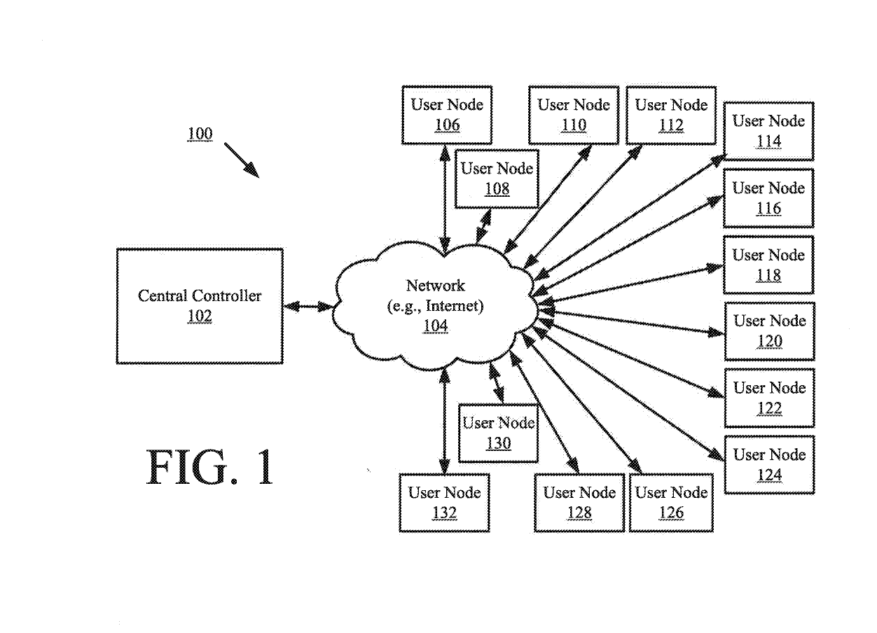

Embodiments of the present invention will now be described with respect to FIGS. 1-9C. The present invention relates to implementing systems and methods for controlling the distribution of media streams (i.e., video and/or audio data) within a teleconference. Such systems/methods of the present invention overcome various drawbacks of conventional teleconferencing systems and methods. For example, the present invention employs a single logical central controller (e.g., central controller 102 of FIG. 1) for controlling the distribution of media streams associated with a teleconference, as opposed to a plurality of MCUs as is employed in conventional teleconference systems. The central controller is logically a single controller because the limits thereon are determined by the work it needs to do in maintaining NNC architectures, rather than processing and/or co-locating media. In some cases, the central controller comprises a cluster of servers. In effect, the present invention reduces the amount of hardware and software infrastructure that a service provider has to provide and support. Thus, the present invention provides a much more cost effective approach to teleconferencing as compared to that provided by conventional teleconferencing techniques. The scale advantages of the present invention at least partially come from the fact that the central controller does not need to be involved in the media path nor mix medial streams.

Additionally, the present invention provides a more resource efficient teleconferencing system as compared to that of conventional teleconferencing systems. In this regard, it should be understood that in the MCU based teleconferencing systems, the video and audio stream quality is static for a given teleconference. In contrast, the video and audio stream quality can be selectively varied for each teleconference occurring in implementing systems of the present invention. Stated differently, the quality of a given teleconference will be varied throughout its lifetime if necessary to maintain the most optimum user experience. This will become more evident as the discussion progresses.

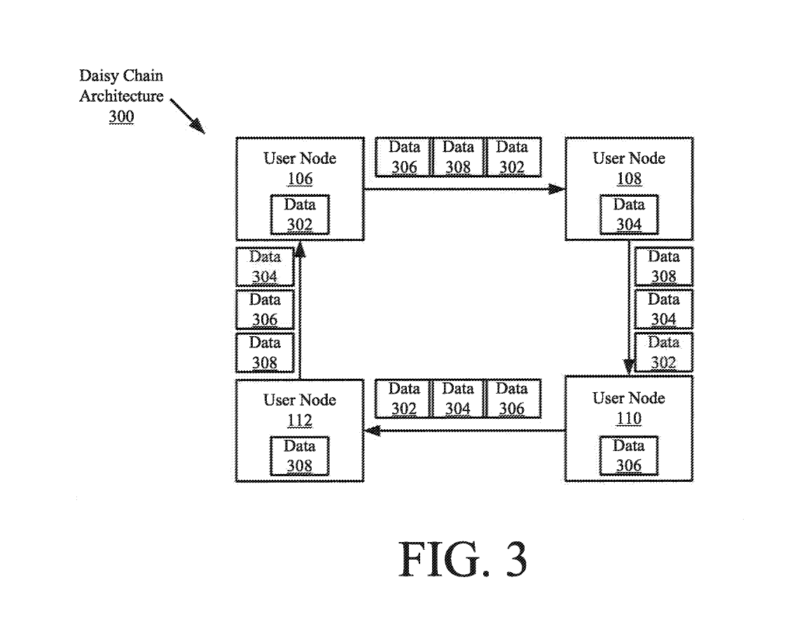

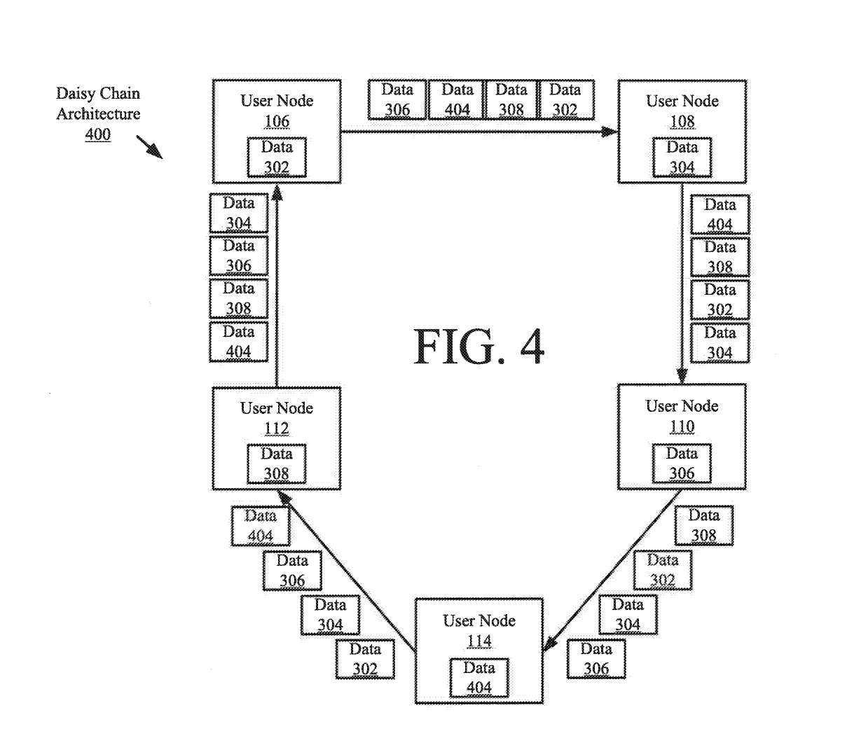

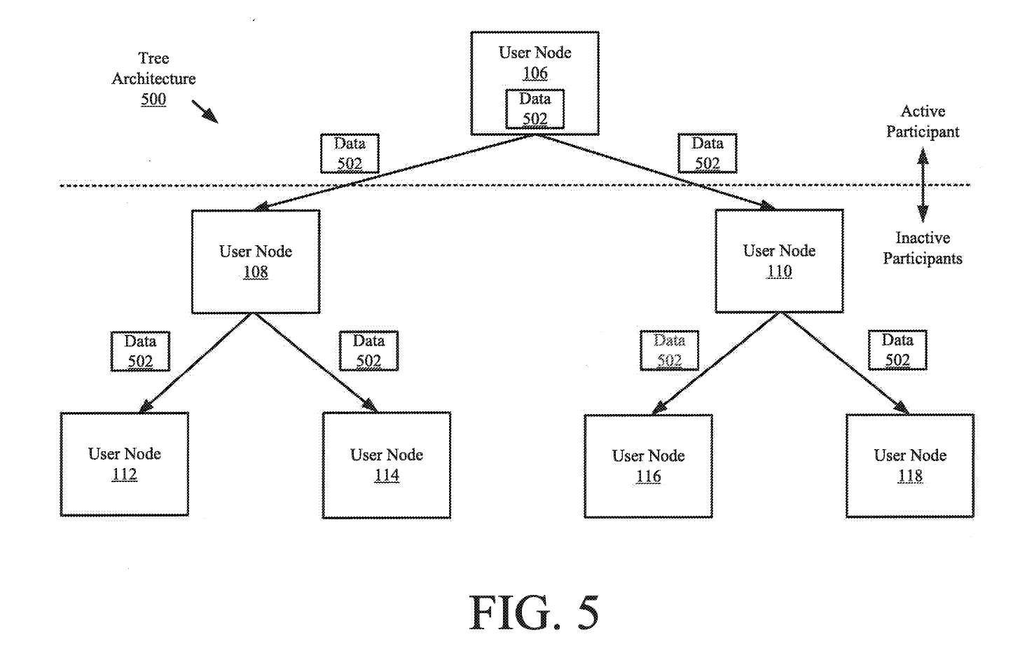

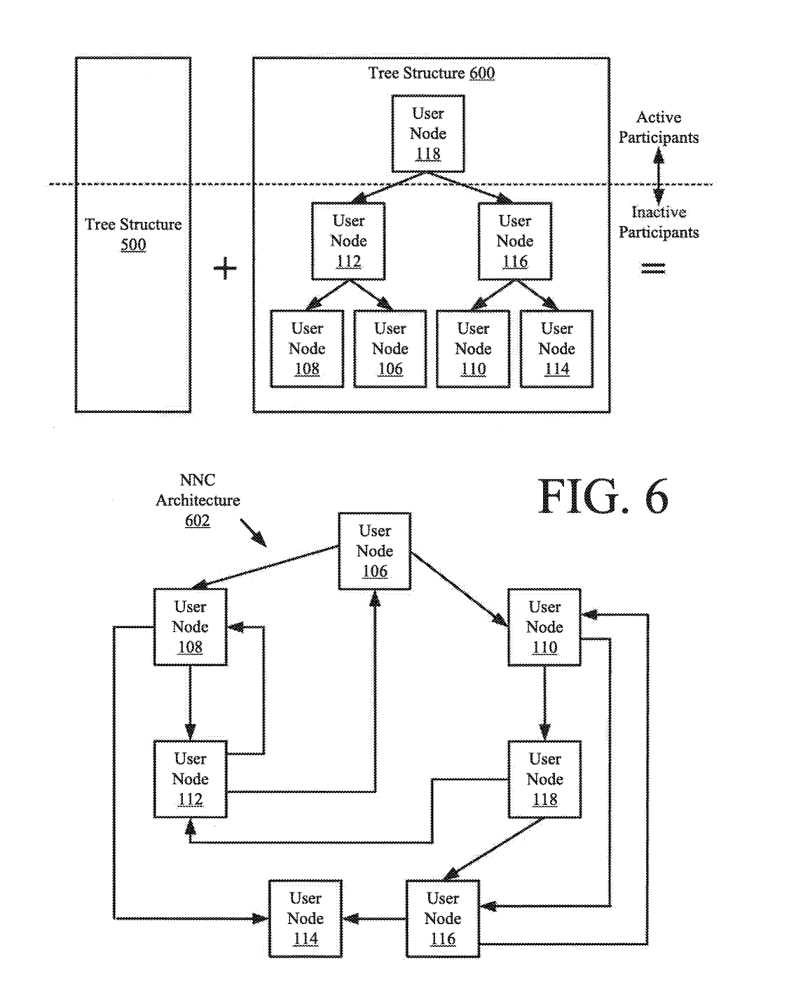

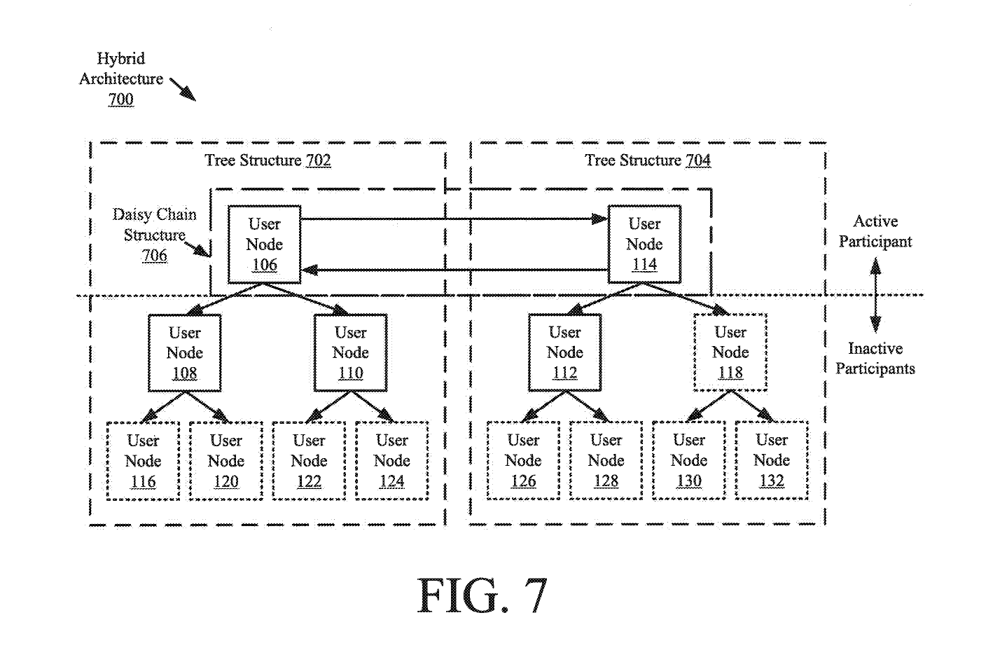

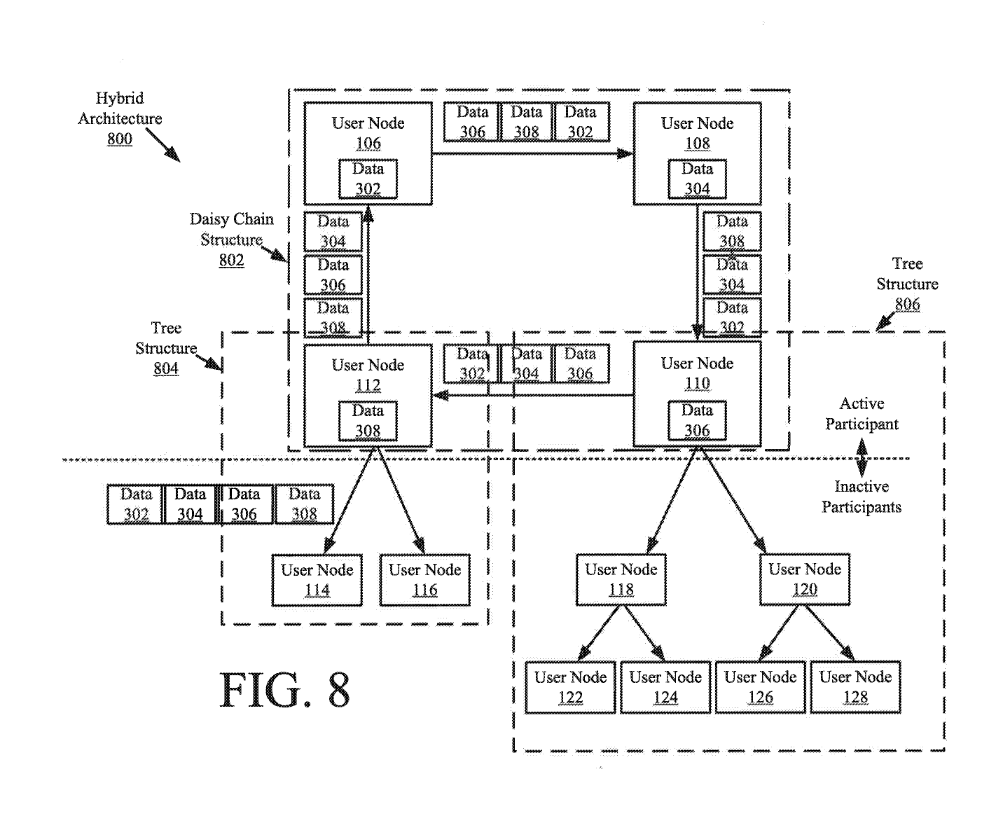

The methods of the present invention generally involve performing operations by a central controller (e.g., central controller 102 of FIG. 1) to dynamically configure an NNC architecture such that data transfer between participants of a teleconference is optimized based on at least one parameter (e.g., latency). The NNC architecture comprises, but is not limited to, a daisy chain architecture (e.g., daisy chain architecture 300 of FIG. 3 or 400 of FIG. 4), a tree architecture (e.g., tree architecture 500 of FIG. 5, 600 of FIG. 6, or 602 of FIG. 6) or a hybrid architecture (e.g., hybrid architecture 700 of FIG. 7 or 800 of FIG. 8). Each of the listed types of NNC architectures will be described in detail below. Still, it should be understood that the daisy chain architecture is used in some scenarios as a default architecture, as well as for small teleconferences having 2-N participants (whom are all or mostly active participants thereof), where N is an integer (e.g., ≦10). In contrast, the tree and hybrid architectures are used in some scenarios for large teleconferences with a relatively large number of participants whom are mostly inactive participants (i.e., those who are just listening to the active participants). A teleconference may be assumed to be a small teleconference until certain bandwidth limits are hit. A teleconference may be determined to be a large teleconference until certain active participants are established.

Notably, participants may freely join or leave a teleconference. As the number of participants increases, the proportion of active participants at any given time decreases. Network nodes of the active participants (e.g., user nodes 106-132 of FIG. 1) are unable to determine when to mute media streams and/or reduce the quality of media streams (e.g., by changing a hit rate of an audio stream or by changing a resolution, frame rate and/or bandwidth of a video stream) so as to optimize performance and user experience for the teleconference, without the assistance of the central controller. As such, the central controller (e.g., central controller 102 of FIG. 1) of the present invention provides a mechanism to dynamically adjust the quality of media streams and/or the manner in which audio and/or video data is distributed to and from participants of a teleconference. The dynamic adjustment can be made in response to (1) changes in a number of participants for a given teleconference, (2) changes in active/inactive statuses of such participants, (3) changes in an end-to-end latency of a node pair, and/or (4) changes in a network or user node capacity to handle all or a portion of the media stream load of a teleconference. As noted above, in conventional teleconference systems, the quality of the media streams communicated during a given teleconference is static. Thus, conventional teleconference systems are far inferior to the implementing systems of the present invention in which media stream quality is dynamically adjusted during a teleconference so as to optimize the quality of user experience during a teleconference.

The NNC architecture approach adopted by the central controller e.g., central controller 102 of FIG. 1) depends on the particular use case, but in general is selected to maximize data sent by network nodes (e.g., user nodes 106-132 of FIG. 1) with the greatest capacity. Accordingly, the central controller employs rules governing when to use a particular NNC architecture approach. For example, a rule may indicate that active nodes are required to constrain the quality of the media streams sent therefrom to a minimum necessary amount. This can be achieved by restricting active nodes from sending 1080p video when 640×480 corresponds better to the size of the media stream. Likewise, active nodes may be restricted to send high definition/quality stereo audio for music and low definition/quality stereo audio for chatter speech. The present invention is not limited in this regard.

There are two main NNC architecture approaches for a teleconference, namely a broadcast use case approach and an open conference use case approach. The central controller ., central controller 102 of FIG. 1) may switch a teleconference between a broadcast use case mode and an open use case mode. The broadcast use case has participants with defined roles (i.e., active or inactive participants). In broadcast use cases where there are a relatively large number of active participants, the central controller makes use of active participant selection mechanism normally used for open conferences.

The open conference use case has N active participants and a relatively large number of inactive participants at any given time. Notably, it is only when the teleconference size grows that the ratio of active participants to inactive participants grows. The participants of an open conference can contribute once for just a few seconds or frequently for varying durations. In more conversational scenarios, the active talker(s) will frequently switch between speaking and silence. As such, the central controller (e.g., central controller 102 of FIG. I) employs measures to ensure that noticeable disruption in the output of video/audio to all the participants of the open conference is avoided as a consequence of the frequent switching between speaking and silence of each participant. Such measures include, but are not limited to, the following: switching the inactive status of a participant relatively quickly to an active status; and switching the active status of the participant relatively slowly to an inactive status. As noted above, the central controller may reconfigure the NNC architecture in response to such switching. NNC architecture reconfigurations may cause disruption in the output of video/audio to all the participants of the open conference. The above-specified switching measures employed by the central controller minimize the number of NNC architecture reconfigurations.

At teleconference start-up, participants will be active for a short period of time. The central controller (e.g., central controller 102 of FIG. 1) has no control on the order in which the participants join and/or leave. As such, the central controller is configured to handle ad-hoc teleconferences where the number of participants at any given time is unknown.

Additionally, the network and device capacity can vary throughout the duration of a teleconference. For example, a mobile participant's bandwidth may vary as a result of movement thereby. Network congestion may impact the effective bandwidth of any participant during a teleconference. End device capacity can vary as other processes are run in parallel. Accordingly, the central controller (e.g., central controller 102 of FIG. 1) is able to adjust the NNC architecture so as to provide optimized distribution of media streams despite such variations in network and device capacity. The central controller may also change the quality of one or more media streams so as to optimize bandwidth utilization by the user nodes.

As noted above, participants may freely join and/or leave a teleconference. The central controller (e.g., central controller 102 of FIG. 1) is configured to avoid any unnecessary NNC architecture changes as participants join/leave the teleconference. The central controller is also configured to recognize differences in behavior of audio and video.

In the open conference use case mode, the central controller (e.g., central controller 102 of FIG. 1) initially places participants into a daisy chain configuration for distributing media streams therebetween. As the number of participants increases, the central controller may reduce the resolution of each video stream to constrain the total bandwidth used by the each network node. As the number of participants increases beyond limits of the daisy chain architecture, the central controller reconfigures the NNC architecture so as to place the participants in a tree configuration for distributing media streams therebetween. The tree configuration is selected such that each participant's media stream can be configured to follow a different route allowing the load to be spread more evenly across participant nodes. Nodes with the greatest capacity are selected to act as relay nodes, as will become more evident below. As more participants join the teleconference, the NNC architecture may again be reconfigured to include a daisy chain architecture, a different tree architecture or a hybrid architecture. In the hybrid architecture, network node of active participants may connect to each other via a daisy chain architecture and connect to network nodes of inactive participants via a tree architecture. The relay nodes comprise those network nodes which form part of the daisy chain architecture and tree architecture.

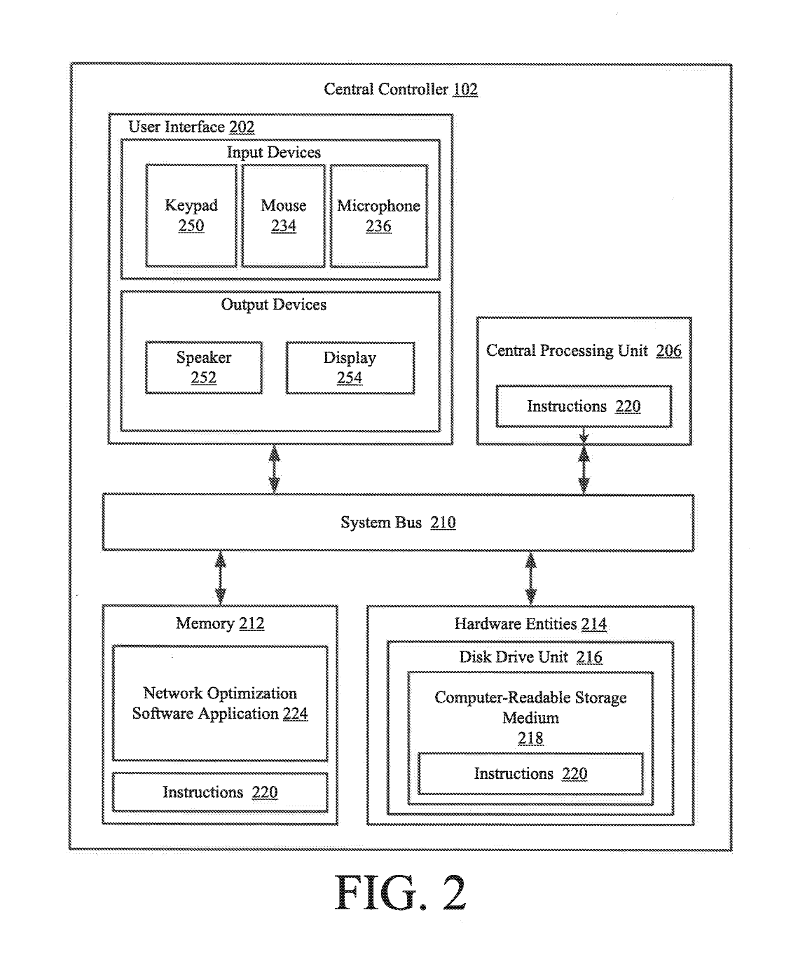

Referring now to FIG. 1, there is provided a schematic illustration of an exemplary system 100 that is useful for understanding the present invention. System 100 is generally configured to provide a novel teleconference service in which media steam flow between network nodes is dynamically optimized. In this regard, system 100 comprises a central controller 102 communicatively coupled to a plurality of user nodes 106-132. A schematic illustration of the central controller 102 is provided in FIG. 2. FIG. 2 will be described in detail below. The user nodes 106432 can include, but are not limited to, personal computers, desktop computers, portable computers, smartphones, and personal digital assistants. Each of the listed types of user nodes is well known in the art, and therefore will not he described herein.

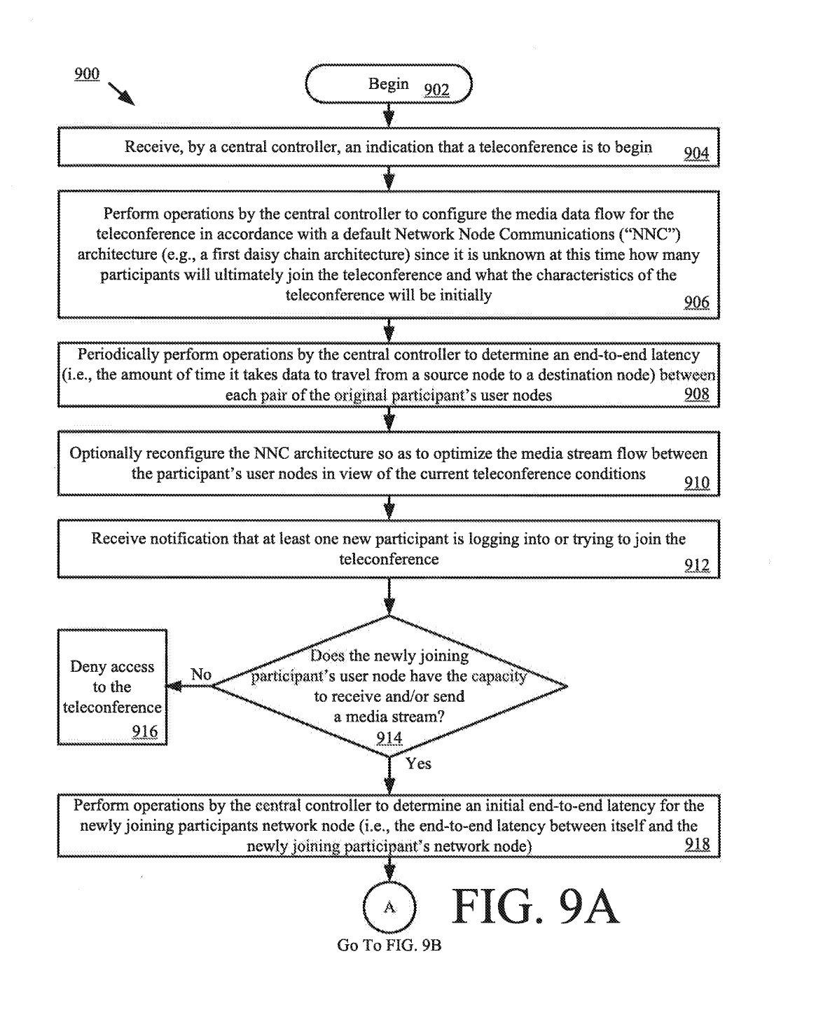

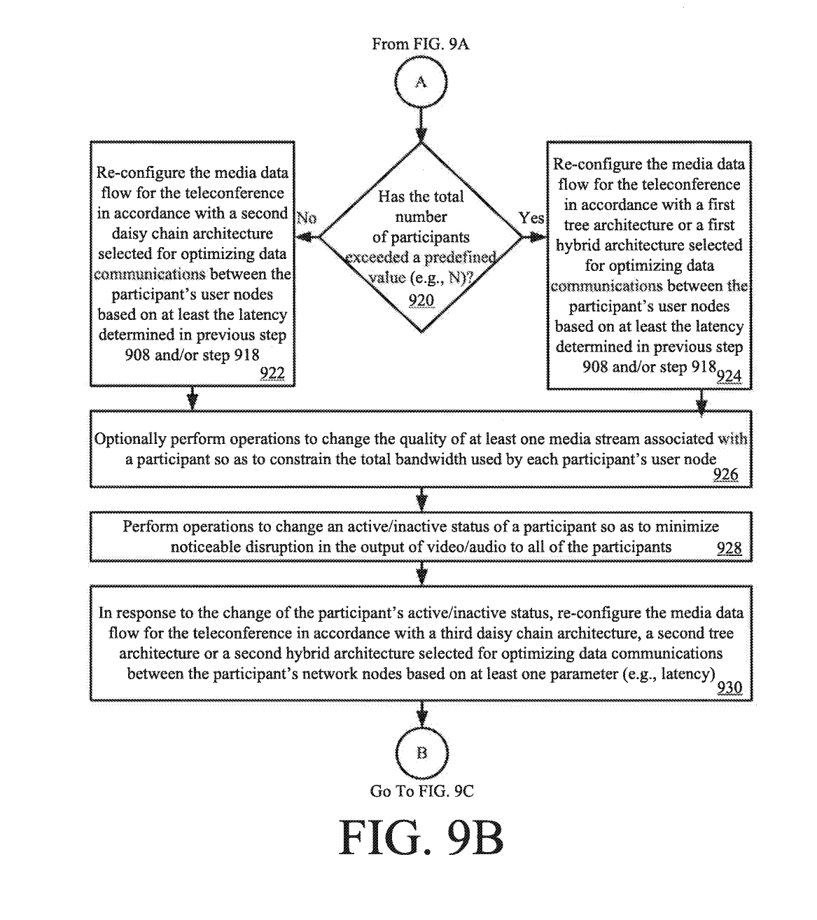

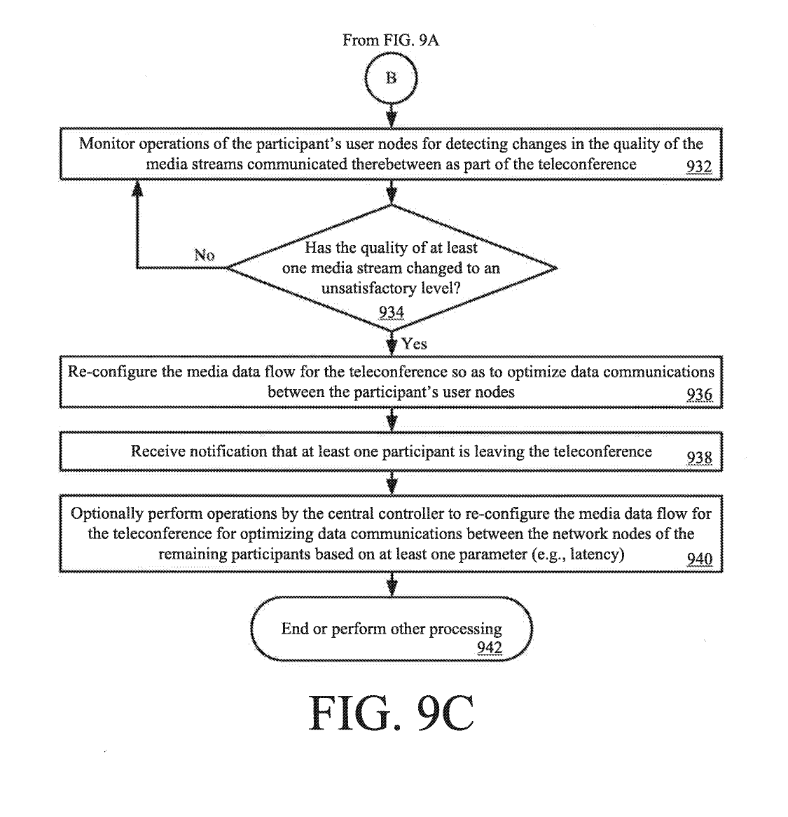

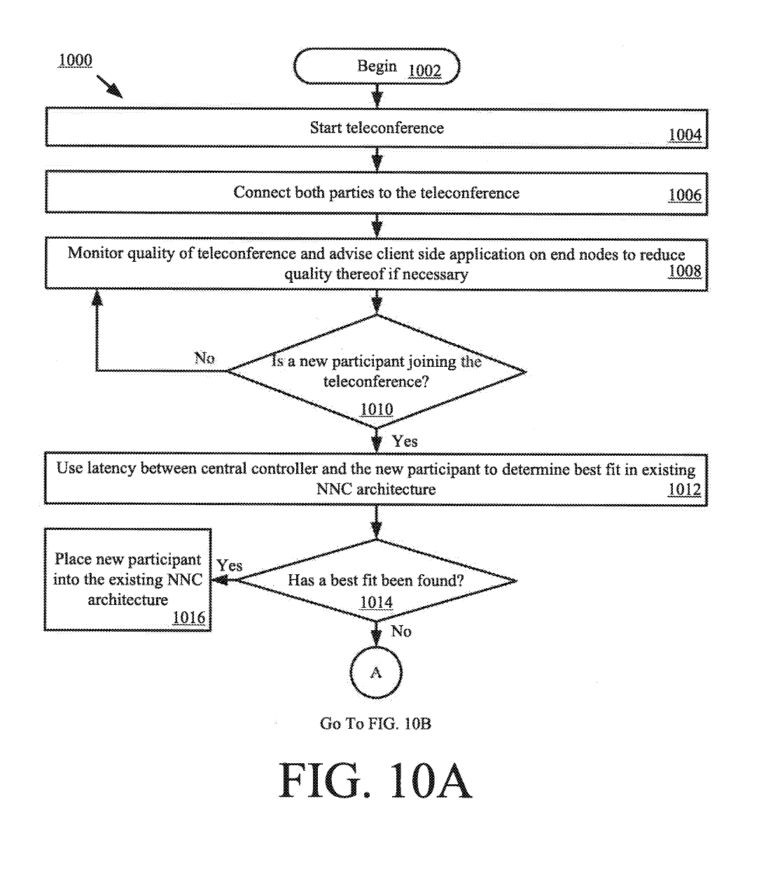

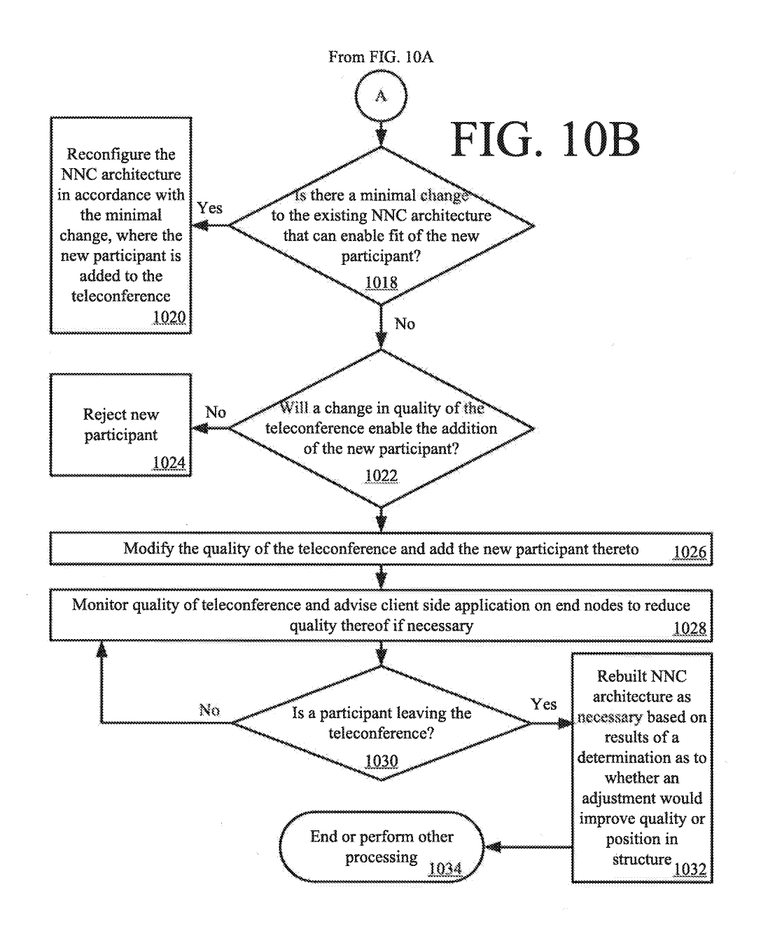

The central controller 102 controls the flow of media streams between the user nodes 106-132 participating in a teleconference. Flow diagrams of exemplary methods for achieving this control are provided in FIGS. 9A-9C and FIGS. 10A-10B. Each method will be described separately below. These figures show various steps performed in a given order. The present invention is not limited to the orders shown in the figures. The steps may be performed in the same or different order than that shown in FIGS. 9A-9C and/or FIGS. 10A-10B. In this regard, it should be understood that the steps in at least FIGS. 9A-9C are ordered for ease of explanation purposes.

Referring now to FIG. 9A, the central controller 102 first performs operations in step 902 to monitor activities of the user nodes 106432 to detect when a teleconference is to begin. Upon such detection, the central controller 102 performs operations to configure the media data flow for the teleconference in accordance with a default NNC architecture, as shown by step 906. The default NNC architecture is employed here since it is unknown at this time how many participants will ultimately join the teleconference and what the characteristics of the teleconference will be initially.

In some scenarios, the default NNC architecture is a daisy chain architecture. A schematic illustration of an exemplary daisy chain architecture 300 is provided in FIG. 3. In the example of FIG. 3, it is assumed that the teleconference initially has only four (4) participants respectively using user nodes 106, 108, 110, 112. The central controller 102 communicates with each user node 106-112 to obtain an initial estimate for an end-to-end latency therefore. The term “end-to-end latency”, as used herein, refers to the amount of time it takes data to travel from a source node to a destination node. Techniques for determining end-to-end latency are well known in the art. Any known or to be known technique for determining end-to-end latency can be used herein without limitation.

Based on the initial end-to-end latency values, the central controller 102 orders the participants into a daisy chain so as to make the best use of the initial estimated end-to-end latencies. For example, assume the end-to-end latency between each user node pair 106/108, 108/110, 110/112, 112/106 is relatively low, and the end-to-end latency between each user node pair 106/110, 108/112, 110/106 is relatively high. In this case, the user nodes are ordered into a daisy chain so as to minimize end-to-end latency between each user node pair. More specifically, the user nodes are ordered such that: user node 106 communicates its media stream data 302 only to user node 108 and receives media stream data 304, 306, 308 generated by user nodes 108-112 only from user node 112; user node 108 sends its media stream data 304 only to user node 110 and receives media stream data 302, 308, 306 for user nodes 106, 110, 112 only from user node 106; user node 110 sends its media stream data 306 only to user node 112 and receives media stream data 302, 304, 308 for user nodes 106, 108, 112 only from user node 108; and user node 112 sends its media stream data 308 only to user node 106 and receives Media stream data 302, 304, 306 for user nodes 106, 108, 110 only from user node 110. Notably, none of the user nodes receives the media stream data which was generated thereby, so as to provide network savings in bandwidth. Also, the total bandwidth required for sending/receiving media streams during the teleconference is divided equally between the user nodes. In this case, each user node is provided 33% of the total bandwidth. The present invention is not limited to the particulars of the exemplary daisy chain 300 shown in FIG. 3.

Referring again to FIG. 9A, the central controller 102 periodically performs operations in step 908 to determine an end-to-end latency between each pair of the original. participant's user nodes. If the end-to-end latency between one or more pairs of user nodes falls below a specified level, then the central controller 102 may perform operations to re-configure the daisy chain so as to optimize the media stream flow between user nodes in view of the current teleconference conditions, as shown by optional step 910.

Sometime thereafter, the central controller 102 receives notification that at least one new participant is logging into or trying to join the teleconference, as shown by step 912. In response to the notification, the central controller 102 performs operations to determine if the newly joining participant's user node has the capacity to receive and/or send a media stream. If the newly joining participant's user node does not have the capacity to receive and/or send a media stream [914:NO], then the newly joining participant is denied access to the teleconference. In contrast, if the newly joining participant's user node does have the capacity to receive and/or send a media stream [914:YES], then step 918 is performed where an initial end-to-end latency therefore is determined.

In a next step 920 of FIG. 9B, a decision is made as to whether the total number of participants now exceeds a predefined value (e.g., N≦10). If the total number of participants does not exceed the predefined value [920:NO], then step 922 is performed where the media data flow for the teleconference is re-configured in accordance with a second daisy chain architecture. In this regard, the user nodes of the original participants and the newly joining participant are ordered into a new daisy chain structure for optimizing data communications therebetween based on at least one parameter (e.g., the end-to-end latency determined in previous steps 908 and 918). The new daisy chain structure can be selected based on at least one of a number of participants of the teleconference, the end-to-end latencies determined for each pair of the user nodes, an active/inactive status of each user node, and a capacity of at least one user node to handle all or a portion of a media stream load of the teleconference.

A schematic illustration of an exemplary daisy chain structure 400 is provided in FIG. 4, where a new participant is joining a teleconference. In the example of FIG. 4, it is assumed that the teleconference previously had four (4) participants respectively using user nodes 106, 108, 110, 112. A participant using user node 114 is now joining the teleconference. As such, the central controller 102 communicates with each user node 106-114 to obtain values for end-to-end latencies therefore. Based on these end-to-end latency values, the central controller 102 orders the participants into a daisy chain so as to make the best use of the end-to-end latencies thereof. For example, assume the end-to-end latency between each user node pair 106/108, 108/110, 110/114, 114/112, 112/106 is relatively low, and the end-to-end latency between each user node pair 106/110, 106/114, 108/114, 108/112, 114/106 is relatively high. In this case, the user nodes are ordered into a daisy chain so as to minimize end-to-end latency between each user node pair. More specifically, the user nodes are ordered such that: user node 106 communicates its media stream data 302 only to user node 108 and receives media stream data 304, 306, 308, 404 generated by user nodes 108-114 only from user node 112; user node 108 sends its media stream data 304 only to user node 110 and receives media stream data 302, 306, 308, 404 for user nodes 106, 110, 112, 114 only from user node 106; user node 110 sends its media stream data 306 only to user node 114 and receives media stream data 304, 302, 308, 404 for user nodes 108, 106, 112, 114 only from user node 108; user node 114 sends its media stream data 404 only to user node 112 and receives media stream data 302-308 for user nodes 106-112 only from user node 110; and user node 112 sends its media stream data 308 only to user node 106 and receives media stream data 302, 304, 306, 404 for user nodes 106, 108, 110, 114 only from user node 114. Notably, none of the user nodes receives the media stream data which was generated thereby, so as to provide network savings in bandwidth. Also, the total bandwidth required for sending/receiving media streams during the teleconference is divided equally between the user nodes. In this case, each user node is provided 25% of the total bandwidth. The present invention is not limited to the particulars of the exemplary daisy chain 400 shown in FIG. 4.

As evident from the forgoing, the daisy chain architecture 400 is relatively easy to construct and maintain since is simply requires renegotiation of media stream flow between adjacent nodes when a participant joins/leaves a teleconference. The daisy chain architecture is sensitive to end-to-end latency as a participant at the end of the daisy chain is X-1 hops away, where X equals the total number of participants in a teleconference. Also, network issues affecting one user node will impact all user nodes further down the daisy chain. Still, the media stream flow is optimized to the capacity of weakest path, and divided equally between all participants.

Retelling again to FIG. 9B, step 924 is performed if the total number of participants does exceed the predefined value [920:YES]. Step 924 involves re-configuring the media data flow for the teleconference in accordance with a first tree architecture or a first hybrid architecture selected for optimizing data communications between the user nodes based on at least one parameter. The parameter can include, but is not limited to, a number of participants of the teleconference, the end-to-end latencies determined for each pair of the user nodes, an active/inactive status of each user node, or a capacity of at least one user node to handle all or a portion of a media stream load of the teleconference.

A schematic illustration of exemplary tree architecture 500 is provided in FIG. 5. In the example of FIG. 5, it is assumed that the teleconference previously had four (4) participants respectively using user nodes 106, 108, 110, 112. A participant using user node 114 is now joining the teleconference so as to cause the capacity of the daisy chain architecture to be exceeded. As such, the central controller 102 communicates with each user node 106-114 to obtain values for end-to-end latencies therefore and/or information indicating an active/inactive status therefore. Based on the end-to-end latency values and/or the active/inactive statuses of the user nodes, the central controller 102 orders the participants into a tree structure so as to spread the load more evenly across the user nodes with network capacity. For example, assume that user node 106 has an active status and user nodes 108-114 have inactive statuses. Also assume that the end-to-end latency between each user node pair 106/108, 106/110, 108/112, 108/114 is relatively low, and the end-to-end latency between each user node pair 106/112, 106/114, 108/110, 110/112, 110/114 is relatively high. In this case, the user nodes are ordered into a tree structure so as to minimize end-to-end latency between each user node pair. More specifically, the user nodes are ordered such that: user node 106 communicates its media stream data 502 to user nodes 108 and 110; and user node 108 forwards the media stream data 502 to user nodes 112 and 114. Notably, user node 106 does not receive media streams from the other user nodes 108-114 since they have inactive statuses. The present invention is not limited to the particulars of the exemplary tree architecture 500 shown in FIG. 5.

As should be understood, the end-to-end latency of the user nodes in a tree structure increases proportionally with each hop. Depending on the use case, the depth of the tree structure and therefore accumulative latency will ultimately limit the number of user nodes forming the tree. in practice, each sending node can send one or more media streams to other receiving nodes depending on its capacity. For example, user node 108 could forward media stream data 502 just to user node 112, with user node 110 forwarding the media stream data 502 to user node 114. Additionally or alternatively, user node 110 may send media stream data 502 to other user nodes 116, 118 which may have also recently joined the teleconference. The present invention is not limited to the particulars of this example.

A schematic illustration of an exemplary hybrid architecture 700 is provided in FIG. 7. In the example of FIG. 7, it is assumed that the teleconference previously had four (4) participants respectively using user nodes 106, 108, 110, 112. A participant using user node 114 is now joining the teleconference so as to cause the capacity of the daisy chain architecture to be exceeded. As such, the central controller 102 communicates with each user node 106-114 to obtain values for end-to-end latencies therefore and/or information indicating an active/inactive status therefore. Based on the end-to-end latency values and/or the active/inactive statuses of the user nodes, the central controller 102 orders the participants into a hybrid structure so as to (a) make the best use of the end-to-end latencies thereof and (b) spread the load more evenly across all the user nodes with network capacity. For example, assume that user nodes 106, 114 have active statuses and user nodes 108-112 have inactive statuses. As such, user nodes 106 and 114 are ordered into a daisy chain structure 706 in which media stream data is sent therebetween (i.e., media stream data generated at user node 106 is sent directly from user node 106 to user node 114, and media stream data generated at user node 114 is sent directly from user node 114 to user node 106). The remaining inactive user nodes 108-112 are then ordered into one or more tree structures 702, 704 for distribution of the media stream data generated by active user nodes 106, 114 thereto. Specifically, user node 106 is ordered to act as a relay node for forwarding the media stream data generated by user node 114 to user nodes 108 and 110. Similarly, user node 114 is ordered to as a relay node for forwarding the media stream data generated by user node 106 to user node 112. The present invention is not limited to the particulars of this example.

As should be understood, the end-to-end latency of the user nodes in each tree structure portion 702, 704 of the hybrid architecture 700 increases proportionally with each hop. Depending on the use case, the depth of each tree structure and therefore accumulative latency will ultimately limit the number of user nodes forming the tree structure portion 702, 704 (e.g., selected to minimize the number of hops and/or ensure that there are only two hops per route). In practice, each sending node can send one or more media streams to other receiving nodes depending on its capacity. For example, user node 108 could be ordered to also act as a relay node for forwarding media stream data generated by user nodes 106, 114 to other user nodes 116, 120 if it has a higher capacity than those other user nodes 116, 120. Likewise, user node 110 could be ordered to also act as a relay node for forwarding media stream data generated by user nodes 106, 114 to other user nodes 122, 124 if it has a higher capacity than those other user nodes 122, 124, and so on. The present invention is not limited to the particulars of this example.

Referring again to FIG. 9B, the method 900 continues with step 926 upon completing step 922 or 924. In step 926, the central controller 102 optionally performs operations to change the quality of at least one media stream associated with a participant of the teleconference so as to constrain the total bandwidth used by each participant's user node. These operations may be performed in response to the detection of an end-to-end latency that falls below a specified level and/or a change in a network/device capacity/state.

In a next step 928, the central controller 102 performs operations to change an active/inactive status of a participant so as to minimize noticeable disruption in the output of video and/or audio to all of the participants of the teleconference. As such, the central controller: switches the inactive status of a participant relatively quickly to an active status; and switches the active status of the participant relatively slowly to an inactive status. In response to the change of the participant(s) active/inactive status, the central controller 102 re-configures the media data flow for the teleconference, as shown by step 930. The media data flow may be re-configured in accordance with a third daisy chain architecture, a second tree structure architecture or a second hybrid architecture. The particular type of NNC architecture is selected for optimizing data communications between the participant's network nodes based on at least one parameter (e.g., end-to-end latency).

Upon completing step 930, the method 900 continues with step 932 of FIG. 9C. In step 932, the central controller 102 monitors operations of the participant user nodes for detecting changes in the quality of the media streams communicated therebetween as part of the teleconference. If the quality of at least one media stream has not changed to an unsatisfactory level [934:NO], then method 900 continues to perform step 932. In contrast, if the quality of at least one media stream has changed to an unsatisfactory level [934:YES], then the central controller 102 re-configures the media data flow for the teleconference so as to optimize the data communications between the user nodes, as shown by step 936.

Sometime thereafter, the central controller 102 receives notification in step 938 that at least one participant is leaving the teleconference. In this case, the central controller 102 optionally performs operations to re-configure the media data flow for the teleconference so as to optimize data communications between user nodes of the remaining participants based on at least one parameter (e.g., latency), as shown by step 940. Notably, step 940 may not be performed if changing the NNC architecture will unnecessarily cause disruption in the output of video/audio to all the participants of the teleconference. Subsequently, step 942 is performed where method 900 ends or other processing is performed.

As noted above, the present invention is not limited to the NNC architectures shown in FIGS. 3, 4, and 5. Other exemplary NNC architectures are shown in FIGS. 6 and 8. Referring now to FIG. 6, a schematic illustration of an exemplary NNC architecture 602 is provided. The NNC architecture is formed by combining the tree structures 500 of FIG. 5 with a tree structure 600 so as to produce a mesh conference with optimized traffic distribution. In this case, there are two active user nodes 106 and 118 respectively using the two separate tree structures 500, 600. The load is spread amongst each user node in accordance with the network capacity thereof while minimizing the number of hops. As shown in FIG. 6, user node 114 has no outbound media streams. User node 116 has one outbound media stream. Each user node 106-112, 118 has two outbound media streams. User nodes 114 and 116 are assumed to have low network capacities as compared to that of the other user nodes. The present invention is not limited to the exemplary NNC architecture of FIG. 6.

Referring now to FIG. 8, a schematic illustration of an exemplary hybrid architecture 800 is provided. In this case, there are four active user nodes 106-112 and eight inactive user nodes 114-128. The four active user nodes 106-112 are arranged in a daisy chain structure 802. Two of the active user nodes 110, 112 respectively form part of separate tree structures 804, 806. The daisy chain structure 802 and tree structures 804, 806 are combined to produce a mesh with optimized traffic distribution. In each tree structure, the load is spread according to each user nodes network capacity while minimizing the number of hops (maximum of two hops). Also, user nodes 108, 114-128 are assumed to have lower capacities as compared to the other user nodes. The present invention is not limited to the exemplary NNC architecture of FIG. 8.

In view of the forgoing, it is evident that all signaling is orchestrated via the central controller 102. All participants communicate with the central controller 102 directly. Signaling follows a client server model, while the media stream flow follows a peer-to-peer model. The capacity of each user node will vary over time. Per hop packet loss and jitter are key metrics, in addition to bandwidth. Connectivity can be asynchronous, and thus there is a need to measure and track inbound and outbound capacity separately.

During operation of system 100, the central controller 102 uses the capacity of each user node and the active/inactive status of each user node to determine a path to all other user nodes that (a) does not over load any individual user node and (b) minimizes the number of hops. The central controller 102 also renegotiates the media stream flow between user nodes according to the determined path. Operations of the user nodes are carefully coordinated by the central controller 102 so as to minimize sending media stream data before full end-to-end paths are negotiated.

As noted above, it may be difficult to avoid visible interruption of media streams as users join and leave a teleconference because of NNC architecture renegotiation. The central controller 102 is configured to allow preservation of paths/routes whenever possible to minimize the impact of a joining/leaving participant. However, when key thresholds are reached, restructuring of the media data flow is necessary.

Different approaches may be used in combination to determine the capacity of each user node. For example, a data channel can be used to simulate a “dummy call” to determine an initial base line value for end-to-end latency, validate that the user node can support at least one call, and/or test the capability of the user node to support additional calls. The “dummy call” can be achieved using a Real-time Transport Protocol (“RTP”) messaging technique. RTP messaging techniques are well known in the art, and therefore will not be described herein. Still, it should be understood that the RTP messaging allows the central controller 102 to monitor live media streams hop-by-hop, receive confirmations that each user node can handle the load of a current media stream, and braces reassurance that any dummy call is not impacting real media streams.

The user's internet connection is likely to be the bottleneck. As such, the central controller also tests for packet loss and jitter experienced by each user node. The packet loss and jitter testing is achieved by communicating messages between the central controller and each user node. The latency between the central controller and each user node is different than the latency between two user nodes. Accordingly, the central controller also conducts tests to determine the latency between each pair of user nodes. Techniques for testing latency, packet loss and jitter are well known in the art. Any known or to be known technique can be used herein without limitation.

Referring now to FIGS. 10A-10B, there is provided a schematic illustration of another exemplary method 1000 for the distribution of media streams during a teleconference. As shown in FIG. 10A, the method 1000 begins with step 1002 and continues with step 1004. In step 1004, a teleconference is started. As such, parties to the teleconference are joined together in step 1006. Thereafter, in step 1008, the central controller monitors the quality of the teleconference, and advises client side teleconferencing applications running on the user nodes to reduce their media stream qualities (if necessary). Next, in step 1010, a determination is made as to whether a new participant is joining the teleconference. If a new participant is not joining the teleconference [1010:NO], the method 1000 returns to step 1008. If a new participant is joining the teleconference [1010:YES], then the central controller determines a best fit in the existing NNC architecture, as shown by step 1012. This determination is based on the latency between the central controller and the new participant. If a best fit is found [1014:YES], then the new participant is placed into the existing NNC architecture. In contrast, if a best fit has not been found [1014:NO], then method 1000 continues with step 1018 of FIG. 10B.

Step 1018 is a decision step in which it is determines whether there is a minimal change to the existing NNC architecture that can enable fit of the new participant. If there is a minimal change to the existing NNC architecture that can enable fit of the new participant [1018:YES], the step 1020 is performed where the NNC architecture is reconfigured in accordance with minimal change, where the new participant is added to the teleconference. If there is no minimal change to the existing NNC architecture that can enable fit of the new participant [1018:NO], the decision step 1022 is performed for determining if a change in the quality of the teleconference will enable the addition of the new participant. If a quality change will not enable the addition of the new participant [1022:YES], then the participant is not allowed to join the teleconference, as shown by step 1024. In contrast, if a quality change will enable the addition of the new participant [1022:YES], then step 1026 is performed. In steo 1026, the quality of the teleconference is modified, and the new participant is added to the teleconference. Next in step 1028, the central controller monitors the quality of the teleconference and advises the client side teleconferencing application to reduce the quality of media stream (if necessary). At some time later, the central controller determines of a participant is leaving the teleconference. If a participant is not leaving the teleconference [1030:NO], method 1000 returns to step 1028. In contrast, if a participant is leaving the teleconference [1030:YES], then step 1032 is performed where the NNC architecture is rebuilt as necessary based on results of a determination as to whether and adjustment would improve quality or position in structure. Subsequently, step 1034 is performed where method 1000 ends or other processing is performed.

Referring now to FIG. 2, there is provided a detailed block diagram of an exemplary architecture for the central controller 102. The central controller 102 may include more or less components than those shown in FIG. 2. However, the components shown are sufficient to disclose an illustrative embodiment implementing the present invention. Some or all of the components of the central controller 102 can be implemented in hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 2, the central controller 102 comprises a user interface 202, a Central Processing Unit (“CPU”) 206, a system bus 210, a memory 212 connected to and accessible by other portions of central controller 102 through system bus 210, and hardware entities 214 connected to system bus 210. The user interface can include input devices (e.g., a keypad 250) and output devices (e.g., speaker 252 and/or a display 254), which facilitate user-software interactions for controlling operations of the central controller 102. For example, a service provider may configured the central controller 102 such that it operations according to specified rules and mathematical algorithms. The service provider may also set threshold and other parameter values using the user interface.

At least some of the hardware entities 214 perform actions involving access to and use of memory 212, which can be a Random Access Memory (“RAM”), a disk driver and/or a Compact Disc Read Only Memory (“CD-ROM”). Hardware entities 214 can include a disk drive unit 216 comprising a computer-readable storage medium 218 on which is stored one or more sets of instructions 220 (e.g., software code) configured to implement one or more of the methodologies, procedures, or functions described herein. The instructions 220 can also reside, completely or at least partially, within the memory 212 and/or within the CPU 206 during execution thereof by the central controller 102. The memory 212 and the CPU 206 also can constitute machine-readable media. The term “machine-readable media”, as used here, refers to a single medium or multiple media (e.g., a centralized or distributed database, and/or associated caches and servers) that store the one or more sets of instructions 220. The term “machine-readable media”, as used here, also refers to any medium that is capable of storing, encoding or carrying a set of instructions 220 for execution by the central controller 102 and that cause the central controller 102 to perform any one or more of the methodologies of the present disclosure.

In some embodiments of the present invention, the hardware entities 214 include an electronic circuit (e.g., a processor) programmed for facilitating the control of media stream distribution amongst user nodes participating in a teleconference. In this regard, it should be understood that the electronic circuit can access and run a software application 224 installed on the central controller 102. The software application 224 is generally operative to facilitate unsecure and/or secure communications with other network nodes of a given network to which the central controller 102 is a member. In this regard, the software application 224 implements some or all of the media stream distribution processes described above.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

What is claimed:

1. A method for controlling distribution of media streams during a teleconference, comprising:
configuring, by a central controller, a media stream flow between user nodes which are participating or are to participate in the teleconference based on one or more first parameters;
periodically determining, by the central controller, an end-to-end latency for each pair of the user nodes during the teleconference; and
dynamically re-configuring, by the central controller, the media stream flow between the user nodes participating in the teleconference in view of the end-to-end latencies which were previously determined.

2. The method according to claim 1, wherein the first parameters comprise an end-to-end latency for each said pair of user nodes and an active/inactive status of each user node.

3. The method according to claim 1, wherein the media stream flow is configured or re-configured by ordering the user nodes into a daisy chain in which each user node sends media streams exclusively to a first user node and receives media streams exclusively from a second different user node.

4. The method according to claim 1, wherein the media streams received by each user node are absent of a media stream generated by that user node.

5. The method according to claim 1, wherein the media stream flow is configured or re-configured by ordering the user nodes into a tree structure in which at least a first user node having an active status communicates a media stream generated thereby to at least one second user node having an inactive status.

6. The method according to claim 5, wherein the second user node acts as a relay node by forwarding the media stream generated by the first user node to at least one third user node having an inactive status.

7. The method according to claim 1, wherein the media stream flow is configured or re-configured by ordering the user nodes into a hybrid structure in which at least first and second user nodes are ordered into a daisy chain architecture for distribution of media streams during the teleconference and at least third and fourth user nodes are ordered into a tree architecture for distribution of media streams during the teleconference.

8. The method according to claim 1, wherein the user nodes are configured into a first Network Node Communication (“NNC”) architecture for distribution of media streams during the teleconference, and subsequently re-configured into a second different NNC architecture for distribution of media streams during the teleconference.

9. The method according to claim 1, wherein the media stream flow is dynamically re-configured in response to at least one of a change in a number of participants of the teleconference, a change in an active/inactive status of at least one user node, a change in an end-to-end latency of at least one user node, a change in a quality of at least one of the media streams, and a change in at least one user node's capacity to handle a portion of a media stream load of the teleconference.

10. The method according to claim 1, further comprising dynamically changing a quality of a media stream associated with one of the user nodes during the teleconference.

11. A teleconference system, comprising:
a central controller controlling distribution of media streams during a teleconference by
configuring a media stream flow between user nodes which are participating or are to participate in the teleconference based on one or more first parameters,
periodically determining an end-to-end latency for each pair of the user nodes during the teleconference, and
dynamically re-configuring the media stream flow between the user nodes participating in the teleconference in view of the end-to-end latencies which were previously determined.

12. The teleconference system according to claim 11, wherein the first parameters comprise an end-to-end latency for each said pair of user nodes and an active/inactive status of each user node.

13. The teleconference system according to claim 11, wherein the media stream flow is configured or re-configured by ordering the user nodes into a daisy chain in which each user node sends media streams exclusively to a first user node and receives media streams exclusively from a second different user node.

14. The teleconference system according to claim 11, wherein the media streams received by each user node are absent of a media stream generated by that user node.

15. The teleconference system according to claim 11, wherein the media stream flow is configured or re-configured by ordering the user nodes into a tree structure in which at least a first user node having an active status communicates a media stream generated thereby to at least one second user node having an inactive status.

16. The teleconference system according to claim 15, wherein the second user node is ordered by the central controller to act as a relay node by forwarding the media stream generated by the first user node to at least one third user node having an inactive status.

17. The teleconference system according to claim 11, wherein the media stream flow is configured or re-configured by ordering the user nodes into a hybrid structure in which at least first and second user nodes are ordered into a daisy chain architecture for distribution of media streams during the teleconference and at least third and fourth user nodes are ordered into a tree architecture for distribution of media streams during the teleconference.

18. The teleconference system according to claim 11, wherein the central controller configures the user nodes into a first Network Node Communication (“NNC”) architecture for distribution of media streams during the teleconference, and subsequently re-configures the user nodes into a second different NNC architecture for distribution of media streams during the teleconference.

19. The teleconference system according to claim 11, wherein the media stream flow is dynamically re-configured in response to at least one of a change in a number of participants of the teleconference, a change in an active/inactive status of at least one user node, a change in an end-to-end latency of at least one user node, a change in a quality of at least one of the media streams, and a change in at least one user node's capacity to handle a portion of a media stream load of the teleconference.

20. The teleconference system according to claim 11, wherein the central controller further dynamically changes a quality of a media stream associated with one of the user nodes during the teleconference.
